(19) United States
(12) Patent Application Publication
(10) Pub. No.: US 2025/0218420 A1
(43) Pub. Date: Jul. 3, 2025

(54) Cyclically-Arranged Split Ring Resonator-Based Acoustic Metamaterial

(71) Applicant: Georgia Tech Research Corporation, Atlanta, GA (US)

(72) Inventors: Michael J. Leamy, Atlanta, GA (US); Prathik Reddy Gunreddy, Atlanta, GA (US)

(21) Appl. No.: 18/982,715

(22) Filed: Dec. 16, 2024

Related U.S. Application Data
(60) Provisional application No. 63/615,834, filed on Dec. 29, 2023.

(51) Int. Cl. G10K 11/172; G10K 11/162

(52) U.S. Cl. CPC G10K 11/172; G10K 11/162

(57) ABSTRACT

An exemplary embodiment of the present disclosure provides an acoustic metamaterial comprising a plurality of unit cells. Each unit cell can comprise a planar layer, a first partial ring in the planar layer, and a second partial ring in the planar layer. The first partial ring can extend around a midpoint of the planar layer and can have a first opening. The second partial ring can extend around the midpoint of the planar layer and can have a second opening.

### CROSS-REFERENCE TO RELATED APPLICATIONS

This application claims the benefit of U.S. Provisional Application Ser. No. 63/615,834, filed on 29 Dec. 2023, which is incorporated herein by reference in its entirety as if fully set forth below.

### FIELD OF THE DISCLOSURE

The various embodiments of the present disclosure relate generally to acoustic attenuating materials.

### BACKGROUND

In automotive engineering, reducing Noise, Vibration and Harshness (NVH) is critical for not only improving occupant's perception of vehicle quality, but also for passenger well-being. In electric vehicles (EVs), the absence of broadband internal combustion engine (ICE) noise makes the presence of harsh or otherwise undesirable frequencies more critical to address. These frequencies, typically in the range of five to ten kHz whining tones, are attributed to electromagnetic forces and gear meshing and represent a fundamental shift in the cabin's acoustic profile compared to ICE-based vehicles. The frequencies contained in EV noise typically exhibit a tonal character which can be evaluated using various metrics such as tone-to-noise ratio (TNR) and prominence ratio (PR). Despite the reduction in overall noise levels associated with EVs, the persistence of tonality within the noise profile continues to present a potential source of discomfort and annoyance. The transfer path for this discomfort into the cabin is provided by both the air medium and the structural components connected to the noise sources.

While airborne noise directly shapes cabin acoustics, the structure-borne noise enters the cabin indirectly via vibrations transmitted through interconnected structural components. Airborne noise comprises sound waves radiated directly into the air medium. It emerges from various sources such as powertrain noise, wind noise, and tire/road noise. Structure-borne noise encompasses elastic waves traveling through solids primarily consisting of transversely and longitudinally polarized vibrations which contribute to the radiation of sound. Longitudinal in-plane waves are also termed “P-waves” in the literature. Transverse waves comprise in-plane shear horizontal (SH) and out-of-plane shear vertical (SV) waves. P-waves and SH-waves transfer vibrations from component to component whereas SV-waves most easily convert structure-borne vibrations into airborne noise—i.e., emitting vibroacoustic energy into the surrounding medium. Some traditionally established techniques to isolate the passenger cabin from airborne and structure-borne noise include rubber mounting and heavy sound-deadening acoustic treatment of body panels, along with optimizing the mounting and suspension design for NVH quality.

Acoustic metamaterials have emerged as promising alternatives to conventionally-used heavy sound insulation sheets to mitigate wave propagation at targeted frequencies. Metamaterials are engineered periodic materials which can be designed to exhibit a frequency stop band (i.e., bandgap) in their band structure. The bandgap is defined to be the range of frequencies over which wave propagation is prohibited. Based on the frequency of operation, metamaterials have a broad range of applications. Researchers have demonstrated the utility of metamaterials in infrastructure sound isolation, energy harvesting, electromagnetic bandgaps, and in aerospace, and automotive applications.

Within the realm of automotive engineering, there is burgeoning interest in metamaterial usage, notably for absorbing acoustic and vibrational energy being transferred into the passenger cabin. Carbody panels have been proven to be a significant contributor for transferring vibroacoustic energy into the cabin. Metamaterials employed in this transfer path mitigate the vibrations to offer a quieter cabin for passenger comfort. Locally resonant metamaterials have been shown as a noise control solution for the low frequency tire noise by installing them on along wheel arches and on the inner lining of the tire. Nissan has proposed a lightweight acoustic metamaterial and demonstrated its capability to mitigate road noise in the 500-1200 Hz range. On a more component level, as we transition from IC engines to electric drivetrains, metamaterials have been considered for isolating the high frequency tonal noise generated from electric motors and inverters. However, the metamaterials showcased in these automotive applications only isolate the vibroacoustic energy emerging from SV waves, leaving consideration of P-waves and SH waves open. By designing lightweight metamaterials for simultaneous mitigation of both in-plane and out-of-plane elastic waves, in a total bandgap, passenger cabin noise levels can be further improved. The present disclosure provides such materials.

### BRIEF SUMMARY

An exemplary embodiment of the present disclosure provides an acoustic metamaterial comprising a plurality of unit cells. Each unit cell can comprise a planar layer, a first partial ring in the planar layer, and a second partial ring in the planar layer. The first partial ring can extend around a midpoint of the planar layer and can have a first opening. The second partial ring can extend around the midpoint of the planar layer and can have a second opening.

In any of the embodiments disclosed herein, the first and second openings can be radially separated around the midpoint by 180 degrees.

In any of the embodiments disclosed herein, the first partial can have a first radius and the second partial ring can have a second radius greater than the first radius.

In any of the embodiments disclosed herein, the first radius can be about 1.75-2.0 mm (e.g., 1.875 mm) mm and the second radius can be about 2.75-3.0 mm (e.g., 2.875 mm).

In any of the embodiments disclosed herein, the first partial ring and the second partial rings can have a radial thickness of about 0.2-0.3 mm (e.g., 0.25 mm).

In any of the embodiments disclosed herein, the first opening can have a width of about 1.0-1.25 mm (e.g., 1.16 mm).

In any of the embodiments disclosed herein, the second opening can have a width of about 1.0-1.25 (e.g., 1.16 mm).

In any of the embodiments disclosed herein, the planar layer can have a thickness of about 0.5-1.5 mm (e.g., 1.0 mm).

In any of the embodiments disclosed herein, the metamaterial can be configured to simultaneously attenuate in-plane and out-of-plane polarized elastic waves (e.g., acoustic and elastic waves) from any direction.

In any of the embodiments disclosed herein, the in-plane waves can comprise longitudinal waves and shear horizontal waves and the out-of-plane waves can comprise shear vertical waves.

In any of the embodiments disclosed herein, the metamaterial can exhibit an out-of-plane bandgap of about 7 to about 9 KHz (e.g., 7.066-9.348 KHz).

In any of the embodiments disclosed herein, the metamaterial can exhibit an in-plane bandgap of about 8 to about 9 KHz (e.g., 8.146-8.807 KHz).

In any of the embodiments disclosed herein, the metamaterial can be customized to specific in-plane and out-of-plane bandgap frequencies by scaling the metamaterial uniformly.

Another embodiment of the present disclosure provides an acoustic metamaterial, comprising a plurality of supercells. Each supercell can comprise first, second, third, and fourth unit cells. Each of the unit cells can comprise a planar layer, a first partial ring in the planar layer, and a second partial ring in the planar layer. The first partial ring can extend around a midpoint of the planar layer and can have a first opening. The second partial ring can extend around a midpoint of the planar layer and can have a second opening. The first, second, third, and fourth unit cells can be arranged in a square lattice, such that adjacent cells are rotated by 90 degrees with respect to each other.

Another embodiment of the present disclosure provides an acoustic metamaterial, comprising: a plurality of unit cells arranged in a lattice. Each unit cell can comprise a midpoint, a first partial ring, and a second partial ring. The first partial ring can have a first radius and extend around the midpoint. The first partial ring can comprise a first opening. The second partial ring can have a second radius greater than the first radius and extend around the midpoint. The second partial ring can comprise a second opening radially separated from the first opening about the midpoint by 180 degrees. The acoustic metamaterial can exhibit an out-of-plane bandgap of about 7 KHz to about 9 KHz (e.g., 7.066-9.348 KHz) and an in-plane bandgap of about 8 KHz to about 9 KHz (e.g., 8.146-8.807 KHz).

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a schematic of a unit cell for a metamaterial, in accordance with an exemplary embodiment of the present disclosure.

FIG. 2 provides a plot of a convergence student of the first eigenfrequency of a unit cell of a metamaterial of the present disclosure.

FIGS. 3A-B provide (3A) a plot illustrating irreducible Brillouin zone of a unit cell (shaded area) of a metamaterial of the present disclosure and (3B) a plot showing unit cell band structure with the propagating model at expected bandgap, with p->0 showing in-plane modes and p->1 showing out-of-plane modes.

FIG. 4 provides an illustration of a metamaterial super cell where the adjacent unit cell is formed by rotating its neighbor by 90 degrees, in which, in the frequency range of interest, cells 100A and 100C resonate in the X and Z direction and cells 100B and 100D resonate in the Y and Z directions, in accordance with some embodiments of the present disclosure.

FIG. 5 illustrates band structure of an exemplary super cell showing the eigenfrequency modes bounding the out-of-plane and in-plane bandgaps.

FIGS. 6A-G provides structural simulation setup for (6A) SV-wave transmission, (6B) P-wave transmission, (6C) acoustic structure simulation setup, (6D) SV-wave transmission plot, (6E) P-wave transmission plot, (6F) band structure for a super cell showing out-of-plane and in-plane bandgaps, and (6G) sound transmission plot against frequency.

FIG. 7 illustrates an exemplary supercell band structure showing original scale and experimental scale frequencies.

FIGS. 8A-C illustrate structural vibration transmission contours for (8A) P-waves, (8B) SH-waves, and (8C) SV-waves. FIGS. 8D-G illustrate (8D) band structure of a super cell with in-plane and out-of-plane bandgaps along with appearance of transmission losses in (8E) P-waves transmission (8F) SH-wave transmission and (8G) SV-wave transmission plots at the targeted frequency range, in accordance with some embodiments of the present disclosure.

FIGS. 9A-B illustrate (9A) an exemplary metamaterial with walls around unit cells and (9B) a aluminum support frame attached to the metamaterial, in accordance with some embodiments of the present disclosure.

FIG. 10 provides a sound transmission plot of an exemplary metamaterial with 1 sample, 2 samples, and 3 samples.

### DETAILED DESCRIPTION

Although preferred exemplary embodiments of the disclosure are explained in detail, it is to be understood that other exemplary embodiments are contemplated. Accordingly, it is not intended that the disclosure is limited in its scope to the details of construction and arrangement of components set forth in the following description or illustrated in the drawings. The disclosure is capable of other exemplary embodiments and of being practiced or carried out in various ways. Also, in describing the preferred exemplary embodiments, specific terminology will be resorted to for the sake of clarity.

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

As used in the specification and the appended claims, the singular forms “a,” “an” and “the” include plural referents unless the context clearly dictates otherwise.

Also, in describing the preferred exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another exemplary embodiment includes from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, member, particle, or method step is present in the composition or article or method, but does not exclude the presence of other compounds, materials, particles, method steps, even if the other such compounds, material, particles, method steps have the same function as what is named.

Mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The materials described as making up the various members of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

The present disclosure provides Split Ring Resonator (SRR)-based acoustic metamaterials. The metamaterials can have a generally planar/sheet design (thus capable of being readily integrated within existing chassis construction) and can exhibit a complete frequency bandgap. These sheets may be curved to form shells with compound curvature. This metamaterial design can be used as an enclosure around tonal noise sources or structurally integrated into car body panels by simple manufacturing techniques such as laser cutting or waterjet machining. The SRRs are specially designed structures that can have ring-like cutouts, leading to resonant elements.

The starting point for some embodiments disclosed herein is a single SRR unit cell configured to align closely its in-plane and out-of-plane resonant frequencies. The influence of the resonator dimensions on the band structure are detailed in C. C. Claeys, K. Vergote, P. Sas, and W. Desmet, “On the potential of tuned resonators to obtain low-frequency vibrational stop bands in periodic panels,” Journal of Sound and Vibration, vol. 332, no. 6, pp. 1418-1436 March 2013, doi: 10.1016/j.jsv.2012.09.047. After finding a close match, to establish symmetry about X and Y axes within the periodically repeating cell, a novel super cell can be constructed by four cyclic rotations of the single unit cell.

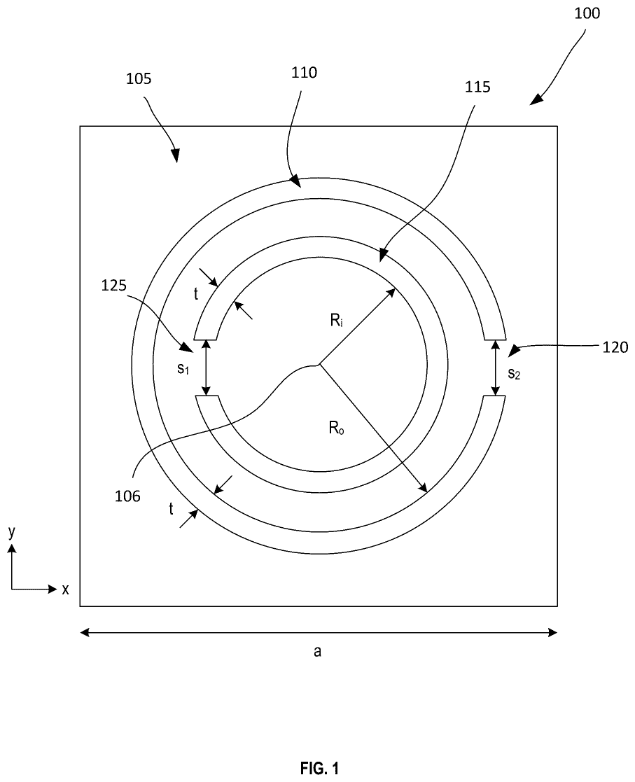

An exemplary unit cell 100 for acoustic metamaterials of the present disclosure is shown in FIG. 1. The unit cell can comprise a generally planar (i.e., sheet like), which can curved/manipulated into any shape layer of material 105. As used herein, the term planar is used to refer to the material in a sheet like layer form, but the resulting metamaterial can be manipulated into many curved or flat shapes, as those skilled in the art would understand. The material 105 can be many materials known in the art, including, but not limited to, aluminum, steel, other metals, polymers, or any automotive composite or alloy, and the like. The planar layer 105 can have a thickness of at least 0.1, at least 0.25, at least 0.5, at least 0.75, at least 1, at least 1.25, at least 1.5, at least 2 mm, or greater for certain applications, in accordance with various embodiments of the present disclosure. In some embodiments, the planar layer can have a thickness of no more than 2, no more than 1.5, no more than 1.25, no more than 1, no more than 0.75, no more than 0.5, or no more than 0.25 mm, in accordance with various embodiments of the present disclosure. Additionally, the planar layer can have a thickness that ranges between any of the upper and lower limits disclosed above, e.g., 0.1-2 mm, 0.75-1.25 mm, etc.

Two partial rings 110 115 can be included in the planar layer 105. The rings 110 115 are “partial” in that each ring can comprise an opening 120 125, such that the rings 110 115 are not entirely circular. Each partial ring 110 115 can extend around a midpoint 106 of the planar layer 105. In some embodiments, the partial rings 110 115 can be formed by cutting away portions of the planar layer 105.

As shown in FIG. 1, the first opening 120 of the first ring 110 and the second opening 125 of the second ring 115 can be radially separated around the midpoint 106 by 180 degrees. The first and second openings 120 125 can have many different widths (denoted by S₁ and S₂ in FIG. 1). In some embodiments, the width of the first and second openings 120 125 can be at least 0.25, at least 0.5, at least 0.75, at least 1, at least 1.25, at least 1.5, at least 1.75 mm, or greater for certain applications, in accordance with various embodiments of the present disclosure. In some embodiments, the width of the first and second openings 120 125 can be no more than 2, no more than 1.75, no more than 1.5, no more than 1.25, no more than 1, no more than 0.75, or no more than 0.5 mm, in accordance with various embodiments of the present disclosure. In some embodiments, the width of the first and second openings 120 125 can range between any of the upper and lower limits disclosed above, e.g., 0.5-1.5 mm, 1-1.25 mm, etc.

The first and second rings 110 115 can have many different radii. In some embodiments, the radius of the first ring 110 (denoted by Rᵢ in FIG. 1) can be less than the radius of the second ring 115 (denoted by Rₒ in FIG. 1). The radii can range many different values. For example, in some embodiments, the first radius (i.e., radius of the first ring 110) can be at least 0.5, at least 0.75, at least 1, at least 1.25, at least 1.5, at least 1.75, at least 2, at least 2.25, at least 2.5, or at least 2.75 mm. In some embodiments, the first radius can be no more than 3, no more than 2.75, no more than 2.5, no more than 2.25, no more than 2, no more than 1.75, no more than 1.5, no more than 1.25, no more than 1, or no more than 0.75 mm. In some embodiments the first radius can range between any of the upper and lower limits disclosed above, e.g., 0.5-3 mm, 1.75-2 mm, etc. Similarly, the second radius (i.e., radius of the second ring 115) can be at least 1.5, at least 1.75, at least 2, at least 2.25, at least 2.5, at least 2.75, at least 3, at least 3.25, at least 3.5, or at least 3.75 mm. In some embodiments, the second radius can be no more than 4, no more than 3.75, no more than 3.5, no more than 3.25, no more than 3, no more than 2.75, no more than 2.5, no more than 2.25, no more than 2, or no more than 1.75 mm. In some embodiments the first radius can range between any of the upper and lower limits disclosed above, e.g., 1.5-4 mm, 2.75-3 mm, etc.

The first and second rings 110 115 can also have many different radial thicknesses (denoted by “t” in FIG. 1). In some embodiments, the first ring 110 can have a first radial thickness and the second ring 115 can have a second different radial thickness. In some embodiments, the radial thicknesses of the first and second rings 110 115 can be the same, and in some embodiments, the radial thicknesses of the first and second rings 110 115 can be different. In some embodiments, the radial thicknesses of the first and second rings 110 115 can be at least 0.1, at least 0.2, at least 0.3, at least 0.4, or at least 0.5 mm. In some embodiments, the radial thicknesses of the first and second rings 110 115 can be no more than 0.5, no more than 0.4, no more than 0.3, no more than 0.2, or no more than 0.1 mm. In some embodiments, the radial thicknesses of the first and second rings 110 115 can range between any of the upper and lower limits disclosed above, e.g., 0.1-0.5 mm, 0.2-0.3 mm, etc.

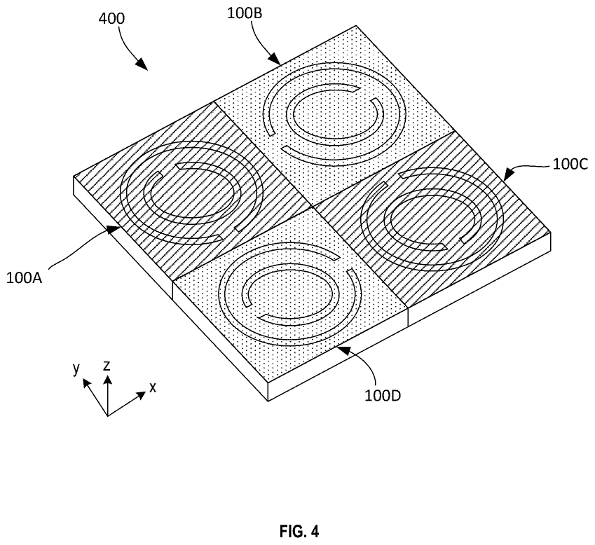

As shown in FIG. 4, four of the unit cells 100A-D discussed above can be combined to form a supercell 400. The four unit cells 100A-D can be arranged in a square lattice, such that adjacent cells are rotated by 90 degrees with respect to each other. For example, in FIG. 4, cell 100B is rotated 90 degrees clockwise as compared to cell 100A, cell 100C is rotated 90 degrees clockwise as compared to cell 100B, cell 100D is rotated 90 degrees clockwise as compared to cell 100C, and cell 100A is rotated 90 degrees clockwise as compared to cell 100D. The supercell 400 can be repeated in a lattice arrangement to create an acoustic metamaterial.

As discussed in more detail in the Examples section below, and as those skilled in the art would understand when reading the present disclosure, the various parameters of the unit cell and supercell (e.g., ring radii, planar layer thickness, planar layer material type, ring radial thickness, opening width, etc.) can be selected such that the metamaterial can prohibit in-plane and out-of-plane elastic waves. Accordingly, the parameters can be selected such that the metamaterial can exhibit an out-of-plane bandgap with a lower frequency of at least 5, at least 5.5, at least 6, at least 6.5, at least 7, at least 7.5, at least 8, at least 8.5, at least 9, at least 9.5, or at least 10 KHz. The parameters can also be selected such that the metamaterial can exhibit an out-of-plane bandgap with an upper frequency of no more than 10, no more than 9.5, no more than 9, no more than 8.5, no more than 8, no more than 7.5, no more than 7, no more than 6.5, no more than 6, or no more than 5.5 KHz. In some embodiments, the parameters can be selected such that the metamaterial exhibits an out-of-plane bandgap that ranges between any of the upper and lower limits disclosed above, e.g, 5-10 KHz, 7-9.5 KHz, etc. Similarly, the parameters can be selected such that the metamaterial can exhibit an in-plane bandgap with a lower frequency of at least 5, at least 5.5, at least 6, at least 6.5, at least 7, at least 7.5, at least 8, at least 8.5, at least 9, at least 9.5, or at least 10 KHz. The parameters can also be selected such that the metamaterial can exhibit an in-plane bandgap with an upper frequency of no more than 10, no more than 9.5, no more than 9, no more than 8.5, no more than 8, no more than 7.5, no more than 7, no more than 6.5, no more than 6, or no more than 5.5 KHz. In some embodiments, the parameters can be selected such that the metamaterial exhibits an in-plane bandgap that ranges between any of the upper and lower limits disclosed above, e.g, 5-10 KHz, 8-9 KHz, etc.

### EXAMPLES

Below, certain exemplary embodiments of the present disclosure are described. This section is provided for illustrative purposes only and should not be construed as limiting the scope of the present disclosure.

### Metamaterial Design

The exemplary metamaterial disclosed below utilizes local resonance phenomena to induce a frequency bandgap within its band structure, thus classifying it as a locally resonant metamaterial (LRM). The presence of resonant frequencies within the metamaterial unit cell opens a frequency window, also referred to as a bandgap, wherein the elastic waves that excite the associated resonant mode cannot propagate through the periodic structure. Within the context of this disclosure, we refer to the bandgap stopping P-waves or SH-waves as the in-plane bandgap, the bandgap stopping SV-waves as the out-of-plane bandgap, and the intersection of the in-plane and out-of-plane bandgaps as a total bandgap. The in-plane waves comprise longitudinal waves and shear horizontal waves, and the out-of-plane waves comprise shear vertical waves. A bandgap can typically be seen in the band structure of the unit cell, which refers to the dispersion relation that characterizes how waves propagate through a metamaterial at different frequencies and along various directions.

FIG. 1 depicts the SRR unit cell design, and Table 1 provides the corresponding geometric parameter values. The unit cell comprises two annular cutouts (or partial ring cutouts)—a smaller one inside a larger one. The larger annular cutout produces a disc-shaped mass with radius R₀ suspended by a compliant tab of width S₂. Embedded inside this suspended mass is another disc-shaped mass of radius Rᵢ produced by a smaller annular cutout and suspended by a compliant tab of width S₁. The smaller and the larger disc masses generally resonate at different frequencies. The material and the dimensions of the tabs can be critical to determining the resonant frequencies of masses as a cantilever in both in-plane (Y) and out-of-plane (Z) directions. Owing to the planar design that can be manufactured using waterjet machining, aluminum was chosen as the material of choice in this example as it is a commonly used material for mounting in the vehicles. The unit cell dimensions were chosen to achieve resonant frequencies that target the pulse width modulated (PWM) switching frequencies of typical EV inverters, which are usually in the 9-10 kHz range.

TABLE 1

| Parameter | Value (mm) |
|---|---|
| Rᵢ | 1.875 |
| R₀ | 2.875 |
| t | 0.25 |
| s | 1.16 |
| a | 7.5 |
| th (thickness) | 1 |

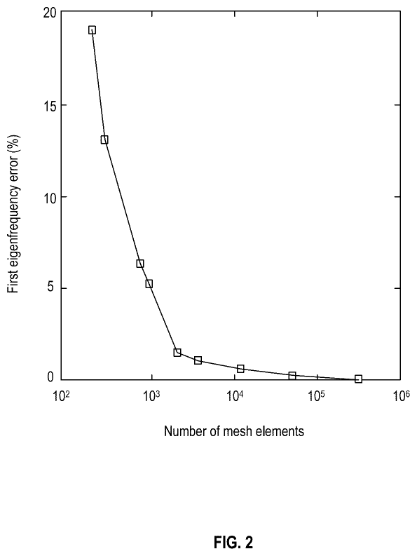

To ensure reliable computational results, we first performed a mesh convergence study of the first eigenfrequency of the unit cell. The material properties used in all the FE simulations are given in Table 2. FIG. 2 shows the percentage deviation of the first eigenfrequency from the converged value plotted against the number of mesh elements on a log scale. To stay within 2% accuracy range, the maximum element size was determined to be 0.75 mm. This element size was used in all the FE simulations discussed in this Example section.

TABLE 2

| Property | Aluminum | Property | Air |
|---|---|---|---|
| Density (kg/m³) | 2700 | Density (kg/m³) | 1.225 |
| Young's Modulus | 69 | Speed of Sound | 343 |
| (GPa) | | (m/s) | |
| Poisson's ratio | 0.33 | | |

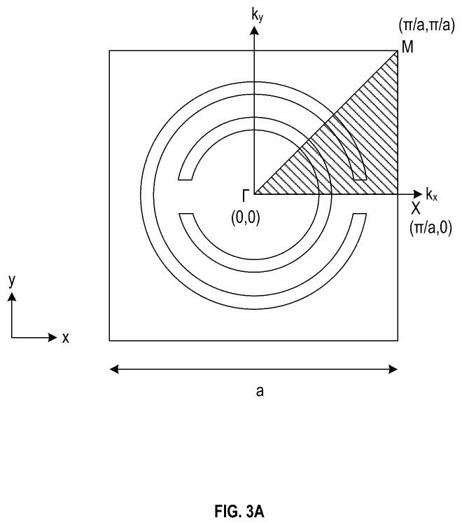

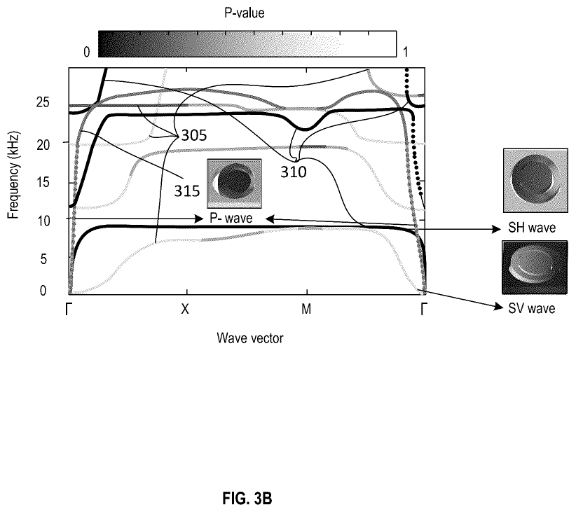

We then computed the band structure of the unit cell by solving an eigenvalue problem. We coupled this eigenvalue problem with Floquet periodic boundary conditions available in an FE package. For a square unit cell, the dispersion curves can be computed by traveling along the boundary of the Irreducible Brillouin Zone in the direction of Γ-X-M-Γ as highlighted in FIG. 3A. These points are also referred to as the high symmetry points of the Brillouin zone [34]. The displacement of the unit cell structure is governed by the Navier-Cauchy equation [35] given by,

$$( λ + μ ) ∇ ( ∇ \cdot u ) + μ ∇ 2 u = ρ \ddot{u} \qquad Equation 1$$

where u(x,y,z)=uî+vĵ+w\hat{k} is the displacement vector, ρ is the material density, and λ, μ are the Lamé constants. FIG. 3B shows the computed band structure for the unit cell. Polarization of each of the eigenmodes is calculated as a volume average of the out-of-plane displacement over the domain given by,

$$ρ = \frac{1}{V} {D}_{} ( \frac{{w}^{2}}{{u}^{2} + {ν}^{2} + {w}^{2}} ) dV \qquad Equation 2$$

where u, v and w are the displacement components in the X, Y and Z directions, Vis the volume of the unit cell and D is the volume domain over which the expression is being integrated. This helps distinguish between the out-of-plane and in-plane modes in the band structure. ρ=0 indicates no out-of-plane displacement and hence a P-wave or SH wave propagating through the unit cell. ρ=1 indicates only out-of-plane displacement portraying the propagation of an SV wave.

The first eigenfrequency of the unit cell is 11.41 kHz, and the outer disc resonates in the Z-direction (out-of-plane mode). The second eigenfrequency is 11.60 kHz and the outer disc resonates in the Y-direction (in-plane mode). These values are significantly closer to each other compared to the next eigenfrequency, which is at 20.21 kHz. We arrive at these values after iterating through the design parameters, attempting to match the in-plane and out-of-plane resonant frequencies as closely as possible. From the perspective of waves propagating in the X-direction, these resonances open a frequency bandgap for SV-waves and SH-waves. In FIG. 3B, we can observe this bandgap among the out-of-plane modes (dispersion curves 305) and in the X-M region of the in-plane modes (dispersion curves 310). However, there still exists a P-wave propagating in X-direction as there is no motion of the resonator in the X-direction (curve 315). We tackle this problem by introducing a longitudinal resonant mode in the X-direction. This is done by extending the design to a super cell, which is further discussed below.

### Cyclic Symmetric Super Cell

Since the designed unit cell is targeted only for SV-waves and SH-waves for propagation in the X-direction, we expand the design to a super cell. The super cell additionally introduces a bandgap in the Γ-X and M-Γ regions of the in-plane modes. FIG. 4 shows the approach to the super cell, which is now a repeating structure in the metamaterial array. A 90 degree rotation of the unit cell leads to resonating modes in the X- and Z-directions. For waves propagating in the Y-direction, Cells 100A and 100C contribute to the attenuation of SV-waves and SH-waves, whereas cells 100B and 100D contribute to the attenuation of SV-waves and P-waves. Similarly, for waves propagating in the X-direction, Cells 100A and 100C contribute to the attenuation of SV-waves and P-waves, whereas cells 100B and 100D contribute to the attenuation of SV-waves and SH-waves. The supercell is therefore able to mitigate the propagation of SH-waves, SV-waves and P-waves in any direction.

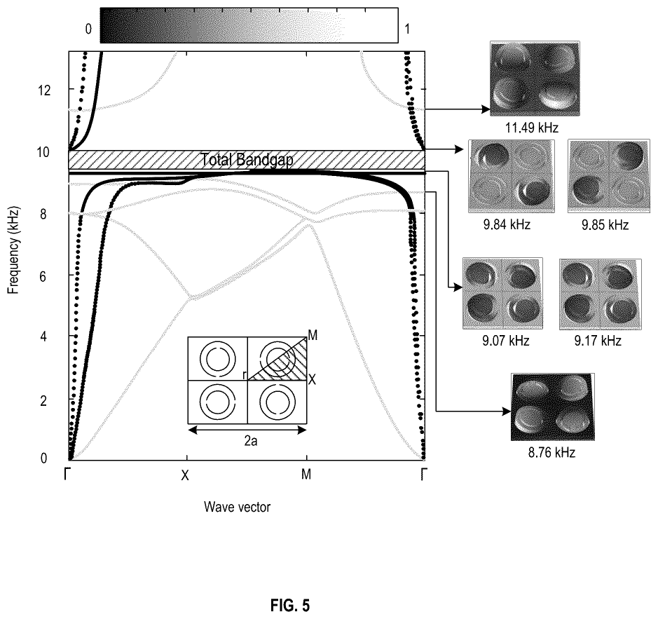

The band structure for the super cell is computed by traveling along the boundary of the IBZ of super cell depicted in FIG. 5. It should be noted here that the periodic cell is now twice in length in each direction, which leads to a change in the coordinates of high-symmetry points in the IBZ. The new coordinates are (0,0), (π/(2a),0) and (π/(2a), π/(2a)) for Γ, X, and M respectively. The 1 mm thick and 15 mm square super cell forms a out-of-plane bandgap between 8.77 kHz-11.49 kHz and an in-plane bandgap in the range of 9.17 kHz-9.84 kHz, as seen in FIG. 5. Since the in-plane bandgap turns falls entirely within the out-of-plane bandgap, we have achieved a total frequency bandgap. This implies that no SH-wave, SV-wave or P-wave containing the specified frequencies can pass through the metamaterial. We also observe that the in-plane and out-of-plane bandgaps are bounded by the corresponding eigenmodes.

### Results

To validate the bandgap computationally, we performed frequency response simulations in structural and acoustic domains. The structure-borne vibration isolation can be verified by sending SH-waves, SV-waves and P-waves over a finite array of super cells. For verifying the acoustic sound transmission loss (STL), we build an acoustic-structure interaction model in FE software to account for the impact of acoustic pressure on the solid walls of metamaterial. This acoustic-structure model is built based on the standardized impedance tube setup. The impedance tube is typically used to measure the acoustic properties of materials, out of which the commonly measured ones are sound absorption coefficient and sound transmission loss. The sound absorption coefficient is measured by placing a sample at the end of the tube and sending acoustic waves from the far end. For the exemplary metamaterial discussed above, we simulate sound transmission loss which requires the sample to be placed in between the incident and transmitted tubes. The setup is further discussed in the acoustic-structure interaction analysis section.

### Structure-Borne Vibration Analysis

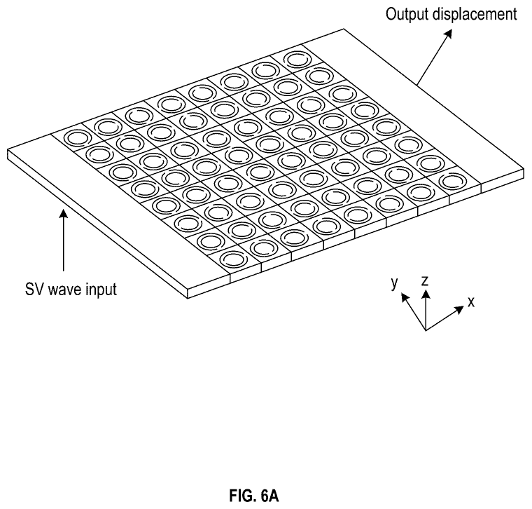

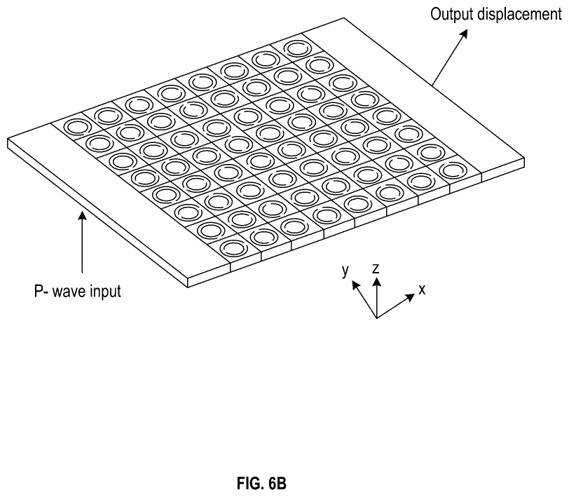

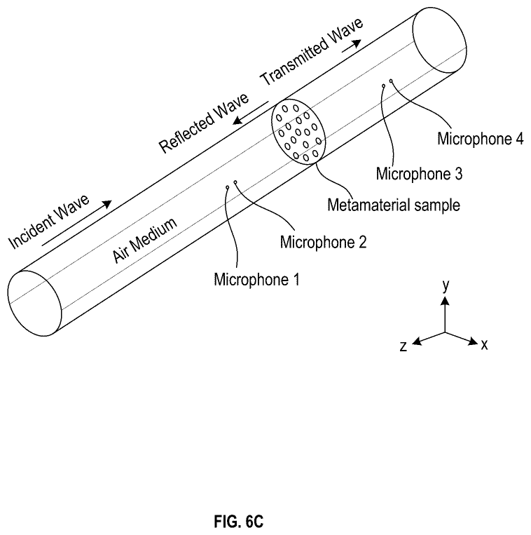

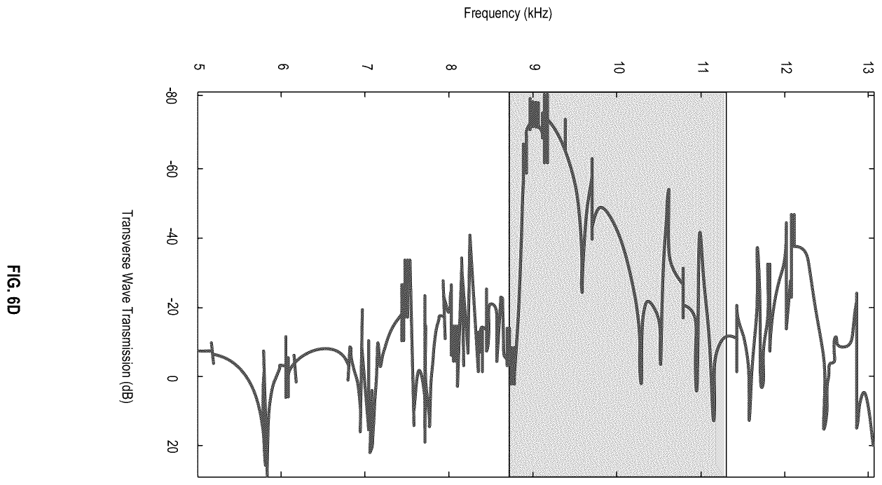

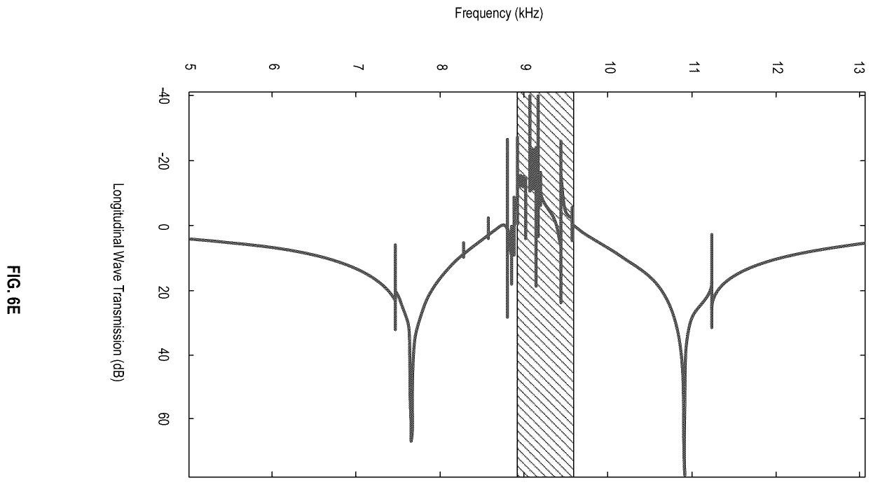

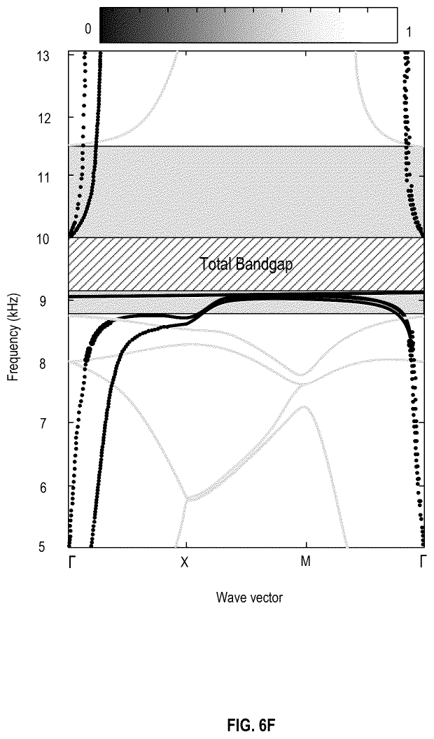

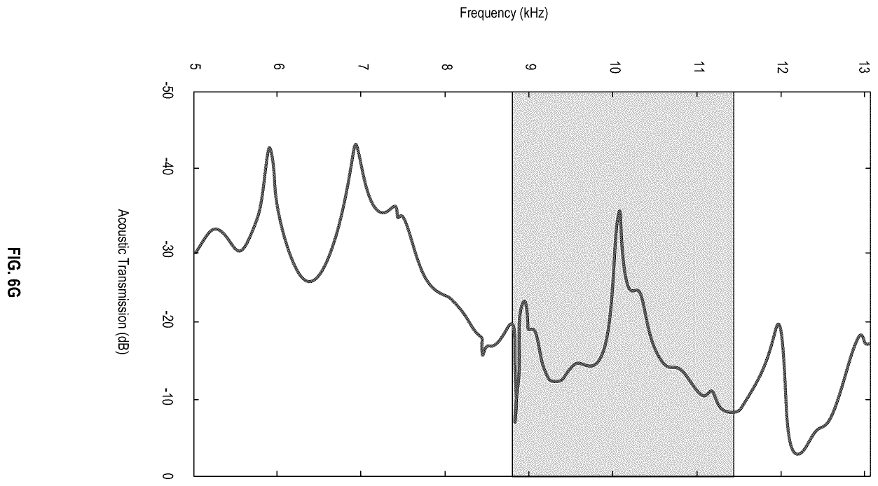

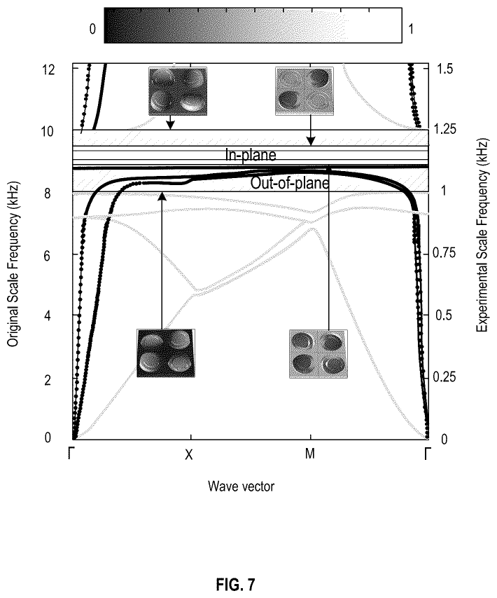

We build a 3D model of a 4×4 array of super cells using a thin sheet of aluminum to verify the frequency dependence of structure-borne vibration transmission. We input displacement vibration on one end face of the sheet and measure the corresponding displacement component (X or Z) on the other end of the structure. FIG. 6A shows the structural simulation setup for transmission of an SV-wave where a harmonic displacement input is given in the Z-direction. FIG. 6B shows the structural simulation setup for transmission of a P-wave where we input a harmonic displacement in X-direction. Because of the super cell symmetry in X- and Y-directions, we can expect similar results for P-waves and SH-waves. Transfer function G is evaluated as the ratio between output displacement and the input displacement amplitudes. Further, the structure-borne transmission in decibels is calculated using,

$${T}_{structual} ( dB ) = 20 {log}_{10} \vert G \vert \qquad Equation 3$$

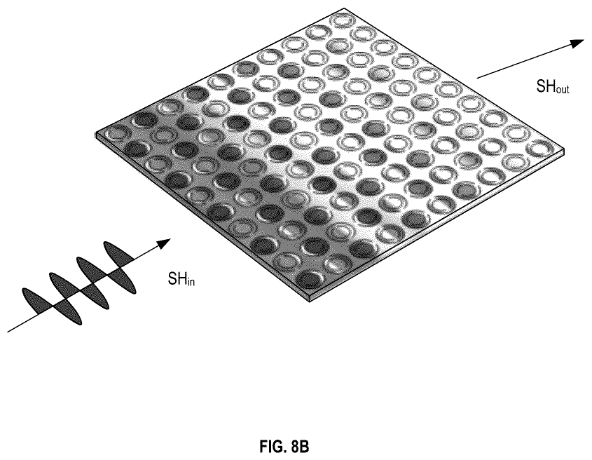

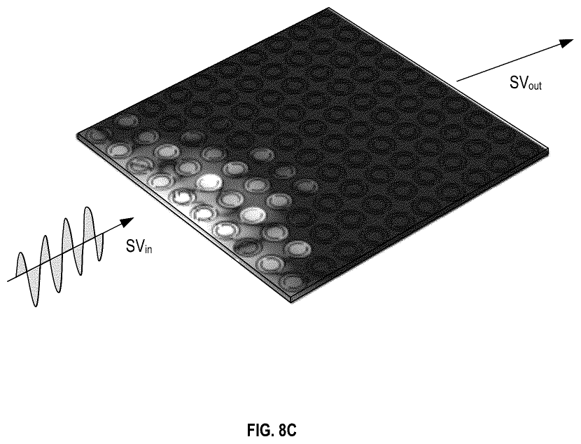

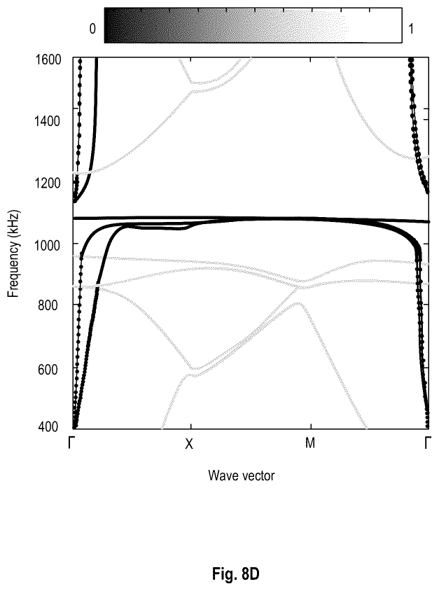

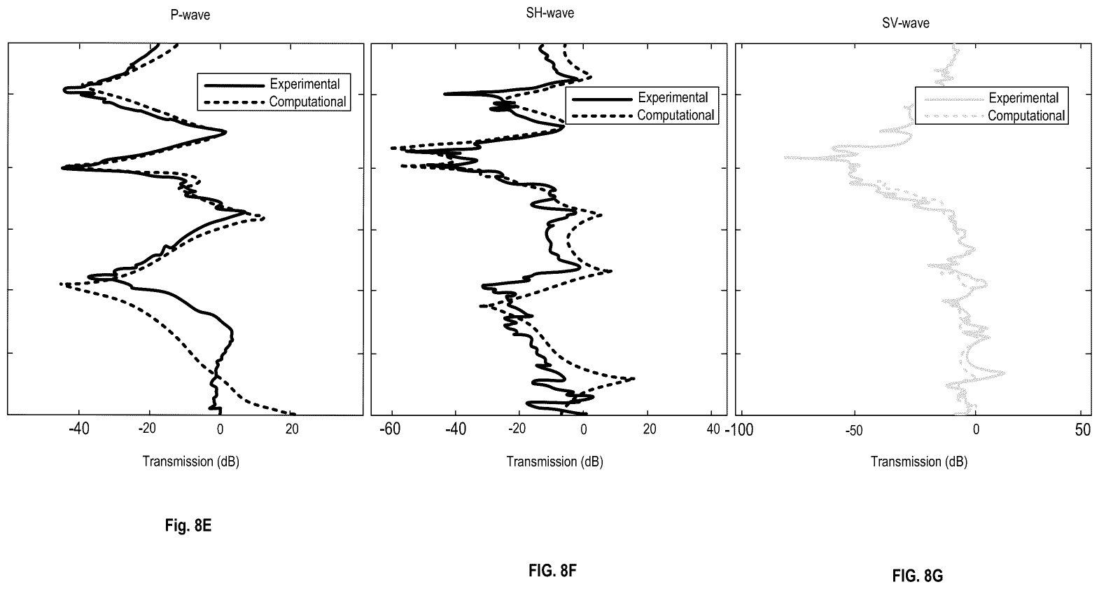

FIGS. 8A-G provide updated plots for experimental and computational transmission plots. The Transmission for the original scale design, however, is presented in FIG. 6D and FIG. 6E, which document the transmission plots for SV- and P-waves, respectively. Frequency in kHz is plotted on the vertical axes, and corresponding transmission in decibels is plotted on the horizontal axes. The simulation is run in the range of 5 kHz-13 kHz to capture the targeted frequency range. While the SV-wave is attenuated by a maximum of 81 dB at 9.14 kHz, the P-wave is attenuated up to 40 dB at 9.16 kHz. We observe the alignment of the frequency bandgap in the band structure with transmission loss region in the plots. As anticipated, we also observe that the attenuation of SV-waves is greater than that of P-waves. This is due to P-waves exciting two unit cells per super cell, whereas SV-waves excite all four unit cells. For instance, in FIG. 4, a P-wave traveling in Y-direction excites only cells 100B and 100D in the targeted frequency range, whereas an SV wave excites cells 100A, 100B, 100C, and 100D since all of them have an out-of-plane resonant mode in the frequency range of interest.

### Airborne Acoustic-Structure Interaction Analysis

We perform the acoustic-structure interaction simulation to test the airborne noise isolation capability of our metamaterial. The model mimics an impedance tube setup, which is commonly used for sound transmission loss measurement. The dimensions of the impedance tube, metamaterial sample and microphone spacing are determined based on the ASTM E1050 standard. As shown in FIG. 6C, the model comprises a circular metamaterial sample placed in between the incident and transmitted air media. The objective of this model is to calculate the transmission of acoustic pressure from the incident medium to the transmitted medium and demonstrate the effectiveness of metamaterial in sound isolation. The material properties of air and aluminum used in the model are given in Table 2.

The curved walls of the impedance tube are modelled using a hard boundary wall condition to represent zero displacement of the fluid particle at the interface. We utilize the perfectly matched layer boundary condition on the planar ends of the tubes to mimic the anechoic termination of the sound waves impinging on the surface. The incident tube domain is subjected to a boundary condition representing a plane wave pressure field propagating in the Z-direction. As the acoustic waves propagate in the incident air medium, upon encountering the metamaterial surface, they undergo strong reflection at the resonant frequency of the resonators. This leads to a significant attenuation of incident waves in the targeted frequency range. This is the case despite air being able to pass through the metamaterial in the regions of the annular cuts.

Microphones are simulated at four points along the centerline of the simulated impedance tube, as required to calculate the sound transmission loss using the four-microphone transfer function method. As the incident wave impinges on the metamaterial surface, a fraction of the wave reflects back, and the remaining fraction is transmitted past the metamaterial. Therefore, the pressure value we measure in the incident tube comprises two components—an incident wave and reflected wave. Similarly, since perfect anechoic termination is very difficult to achieve, the pressure in the transmitted medium also comprises of transmitted and second reflected waves (first reflection is the reflection from the metamaterial sample, and second reflection is the reflection from the anechoic termination). The use of two microphones on each side aids in decomposing the measured pressure into incident, transmitted, and reflected waves. This decomposition leads to,

$$A = \frac{( {P}_{1} {e}^{{jkx}_{2}} - {P}_{2} {e}^{{jkx}_{1}} ) {e}^{- j ω t}}{( {e}^{- jk ( {x}_{1} - {x}_{2} )} - {e}^{jk ( {x}_{1} - {x}_{2} )} )} \qquad Equation 4$$

$$C = \frac{( {P}_{3} {e}^{{jkx}_{4}} - {P}_{4} {e}^{{jkx}_{3}} ) {e}^{- j ω t}}{( {e}^{- jk ( {x}_{3} - {x}_{4} )} - {e}^{jk ( {x}_{3} - {x}_{4} )} )} \qquad Equation 5$$

where P₁, P₂, P₃, and P₄ denote the root mean square (rms) pressure values measured at the microphone locations 1, 2, 3 and 4, respectively; x₁, x₂, x₃, x₄ are distances of microphones from the incident surface of the metamaterial sample; A, C are the amplitudes of the incident and transmitted waves respectively; and k denotes the wave number corresponding to the frequency at which the expression is being evaluated. The term e^{-jωt} vanishes on taking the ratio of C and A for evaluating the transmission coefficient. The acoustic transmission can be evaluated as,

$${T}_{acoustic} ( dB ) = 20 {log}_{10} \vert \frac{C}{A} \vert \qquad Equation 6$$

FIG. 6G provides the acoustic transmission plot where frequency in kHz is plotted on the vertical axis and corresponding acoustic transmission in decibels is plotted on the horizontal axis. We observe a transmission loss of around 34 dB at 10.06 kHz. This loss region also aligns well with the out-of-plane bandgap, implying the excitation of out-of-plane resonant modes of the super cell. The dB loss, however, cannot be compared with the structural simulation dB loss because the transfer function is evaluated using different physical quantities: while particle displacement is used for structural waves, acoustic pressure is used for sound waves. We note that 34 dB sound transmission loss implies a 98% decrease in sound energy.

### Scalability

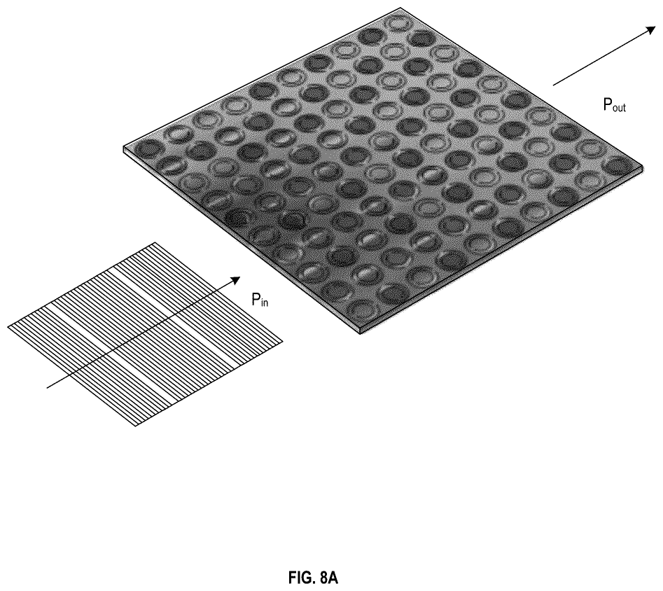

The initial design of the exemplary super cell described above was intended for the attenuation of higher inverter frequencies around 9-10 kHz. However, validating these frequencies in an impedance tube setup can be impractical due to the frequency limitations posed by the tube dimensions. For expeditious prototyping, our test samples can be fabricated using PLA with a uniform scaling of the super cell by a factor of 2.4. This scale can be referred to as experimental scale. A reduction in elastic modulus can accompany an increase in mass and dimensions to result in a predictable shift in the bandgap, along with the resonant frequencies of the unit cell, as depicted in FIG. 7. This predictable shift can offer a customizable design option depending on the material being used and the measured frequencies from noise sources.

### Structure-Borne Vibration Transmission

A 6×6 array of unit cells was built on a 2.4 mm sheet of PLA. This sample was suspended by 4 springs attached to the optical posts at 4 corners of the sample via 3D printed sprinted spring holders. Frequency response simulation was performed in COMSOL structural domain to verify the attenuation of bulk elastic waves passing through the metamaterial. FIGS. 8A-C depict the wave propagation of P, SH and SV waves through the sample. FIGS. 8D-G plot the experimental and computational transmission (dB) in the range of 400-1600 Hz. A close match between experimental and computational results can be observed. The transmission losses at undesired frequencies, however, can arise due to the resistance from the springs to cause in-plane motion resulting in rigid body vibration.

### Air-Borne Noise Transmission

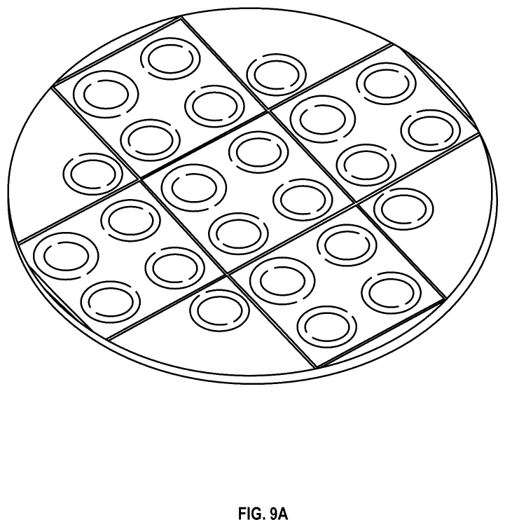

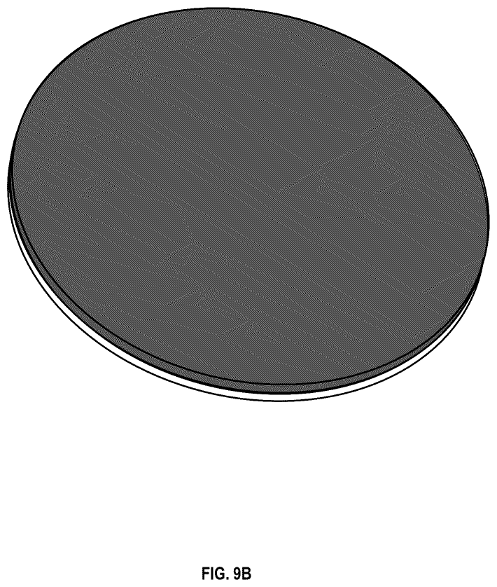

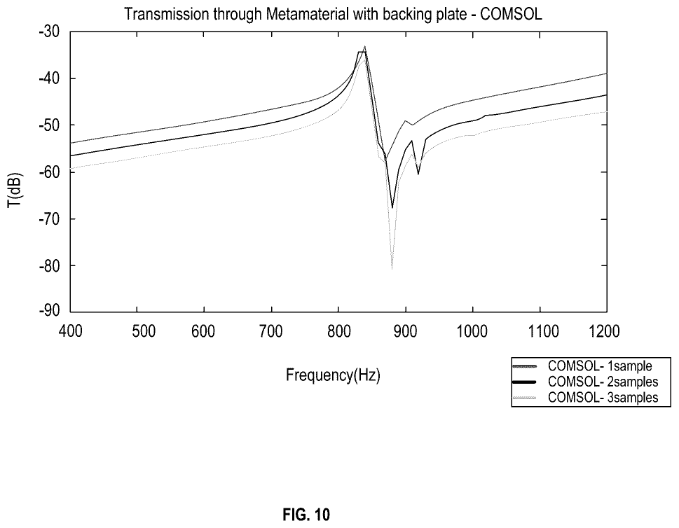

Due to the planar nature of the metamaterial, there may be no periodicity in the perpendicular direction. To induce SV waves in the material from the incident acoustic waves, we attach a 4 mm thick aluminum support frame to the structure. This frame can be attached to the walls built around each unit cell of the metamaterial structure as shown in FIGS. 9A-B. As shown in FIG. 10, the computational results showed a sharp dip in transmission at the resonant frequencies of the metamaterial unit cells, and the transmission loss increases as more number of metamaterial samples are added.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. An acoustic metamaterial comprising:
a plurality of unit cells, each unit cell comprising:
a planar layer;
a first partial ring in the planar layer extending around a midpoint of the planar layer, the first partial ring having a first opening; and
a second partial ring in the planar layer extending around the midpoint of the planar layer, the second partial ring having a second opening.

2. The acoustic metamaterial of claim 1, wherein the first and second openings are radially separated around the midpoint by 180 degrees.

3. The acoustic metamaterial of claim 1, wherein the first partial ring has first radius and the second partial ring has a second radius greater than the first radius.

4. The acoustic metamaterial of claim 3, wherein the planar layer comprises steel or aluminum, and wherein the first radius is about 1.75-2.0 mm and the second radius is 2.75-3.0 mm.

5. The acoustic metamaterial of claim 1, wherein the planar layer comprises steel or aluminum, and wherein the first partial ring and the second partial rings have radial thickness of about 0.2-0.3 mm.

6. The acoustic metamaterial of claim 1, wherein the planar layer comprises steel or aluminum, and wherein the first opening as a width of about 1.0-1.25 mm.

7. The acoustic metamaterial of claim 6, wherein the second opening has a width of 1.0-1.25 mm.

8. The acoustic metamaterial of claim 1, wherein the planar layer comprises steel or aluminum, and wherein the planar layer has a thickness of 1 mm.

9. The acoustic metamaterial of claim 1, wherein the material is configured to simultaneously attenuate in-plane and out-of-plane polarized elastic waves from any direction.

10. The acoustic metamaterial of claim 9, wherein the in-plane waves comprise longitudinal waves and shear horizontal waves, and wherein the out-of-plane waves comprise shear vertical waves.

11. The acoustic metamaterial of claim 1, wherein the metamaterial exhibits an out-of-plane bandgap of about 7 to about 9.5 KHz.

12. The acoustic metamaterial of claim 1, wherein the metamaterial exhibits an in-plane bandgap of about 8 to about 9 KHz.

13. An acoustic metamaterial, comprising:
a plurality of supercells, each supercell comprising first, second, third, and fourth unit cells, each of the unit cells comprising:
a planar layer;
a first partial ring in the planar layer extending around a midpoint of the planar layer, the first partial ring having a first opening; and
a second partial ring in the planar layer extending around the midpoint of the planar layer, the second partial ring having a second opening;
wherein the first, second, third, and fourth unit cells are arranged in a square lattice, such that adjacent cells are rotated by 90 degrees with respect to each other.

14. The acoustic metamaterial of claim 13, wherein the first and second openings are radially separated around the midpoint by 180 degrees.

15. The acoustic metamaterial of claim 13, wherein the first partial ring has first radius and the second partial ring has a second radius greater than the first radius.

16. The acoustic metamaterial of claim 15, wherein the first radius is about 1.75-2.0 mm and the second radius is about 2.75-3.0 mm.

17. The acoustic metamaterial of claim 13, wherein the first partial ring and the second partial rings have radial thickness of about 0.2-0.3 mm.

18. The acoustic metamaterial of claim 13, wherein the first opening as a width of about 1.0-1.25 mm and the second opening has a width of about 1.0-1.25 mm.

19. The acoustic metamaterial of claim 13, wherein the metamaterial exhibits an out-of-plane bandgap of about 7 to about 9.5 KHz and an in-plane bandgap of about 8 to about 9 KHz.

20. An acoustic metamaterial, comprising:
a plurality of unit cells arranged in a lattice, each unit cell comprising:
a midpoint;
a first partial ring having a first radius and extending around the midpoint, the first partial ring comprising a first opening; and
a second partial ring having a second radius greater than the first radius and extending around the midpoint, the second partial ring comprising a second opening radially separated from the first opening about the midpoint by 180 degrees,
wherein the acoustic metamaterial exhibits a out-of-plane bandgap of about 7 to about 9 KHz and an in-plane bandgap of about 8 to about 9 KHz.
